(19) United States
(12) Patent Application Publication
(10) Pub. No.: US 2005/0050390 A1
(43) Pub. Date: Mar. 3, 2005

(54) Digital data transmitter

(76) Inventor: Henry Lee, Chung-Ho City (TW)

Correspondence Address: Power 7 Technology Corp., P.O. Box No. 6-57, Junghe, Taipei, 235, TW

(21) Appl. No.: 10/651,947

(22) Filed: Sep. 2, 2003

(51) Int. Cl. G06F 11/00

(52) U.S. Cl. 714/18

(57) ABSTRACT

A digital data transmitter includes a circuit board having at least a power circuit, a universal serial bus (USB) interface circuit, a central processing unit (CPU) and two connectors. The connectors are high-speed transmission USB connectors. To transmit digital data stored in a specific information product to another information product, the two information products are connected to the high-speed transmitter, thereby directly transmitting and storing data via the CPU without requiring computers as media as in conventional transmission means. Being free of restrictions of computer hosts, the digital data transmitter enables a user to quickly transmit and store digital data at all time.

### BACKGROUND OF THE INVENTION

(a) Field of the Invention

The invention relates to a digital data transmitter, and more particularly, to digital data transmitter that, without requiring computers as media, enables a user to directly transmit and store digital data stored in information products between the information products.

(b) Description of the Prior Art

Accompanied with rapid advancement of information technology, transmission rate and storage capacity of digital data are being significantly increased as well. Huge amounts of digital data are stored and accessed by computers from information products such as portable disks, pen recorders, personal digital assistants (PDA), personal video recorders (PVR), digital static cameras (DSC), universal serial bus (USB) compact disk read-only-memories (CD-ROM), audio/video (A/V) decoders, motion picture expert group 2layer3 (MP3) players, and card readers. In order to transmit data between these information devices, a commonly used method is to connect cables of these information devices to a computer, and then to transmit and store, or access one another's digital data using a computer host as a medium. However, this method is only completed in the presence of media namely computer hosts, meaning that a computer host is necessarily available at the time of transmission. It is recognized that computers are not always obtainable in actual situations, or one may not definitely find idle computers that can be applied. Thus, perplexities are often caused.

### SUMMARY OF THE INVENTION

The primary object of the invention is to provide a digital transmitter through which, without requiring a computer as a medium, enables direct data transmission of digital data stored in various information products between the information products.

The digital data transmitter according to the invention comprises the characteristics of: a circuit board having at least a power circuit, a universal serial bus (USB) interface, a central processing unit (CPU) and two connectors. The connectors are high-speed transmission USB connectors. To transmit digital data stored in a specific information product to another information product, the two information products are connected to the high-speed connectors, thereby directly transmitting and storing data via the CPU.

According to the aforesaid characteristics, the high-speed transmission connectors are USB connectors.

### BRIEF DESCRIPTION OF THE DRAWINGS

FIG. 1 shows a circuit block diagram in an embodiment according to the invention.

FIG. 2 shows a circuit block diagram in another embodiment according to the invention.

FIG. 3 shows a simplified elevational structural schematic view of the embodiment in FIG. 2.

FIG. 4 shows a schematic view illustrating an application of the digital data transmitter according to the invention being connected to various digital information products, thereby directly transmitting digital data between the information products directly connected using USB connectors or indirectly connected using USB connecting cables.

### DETAILED DESCRIPTION OF THE PREFERRED EMBODIMENTS

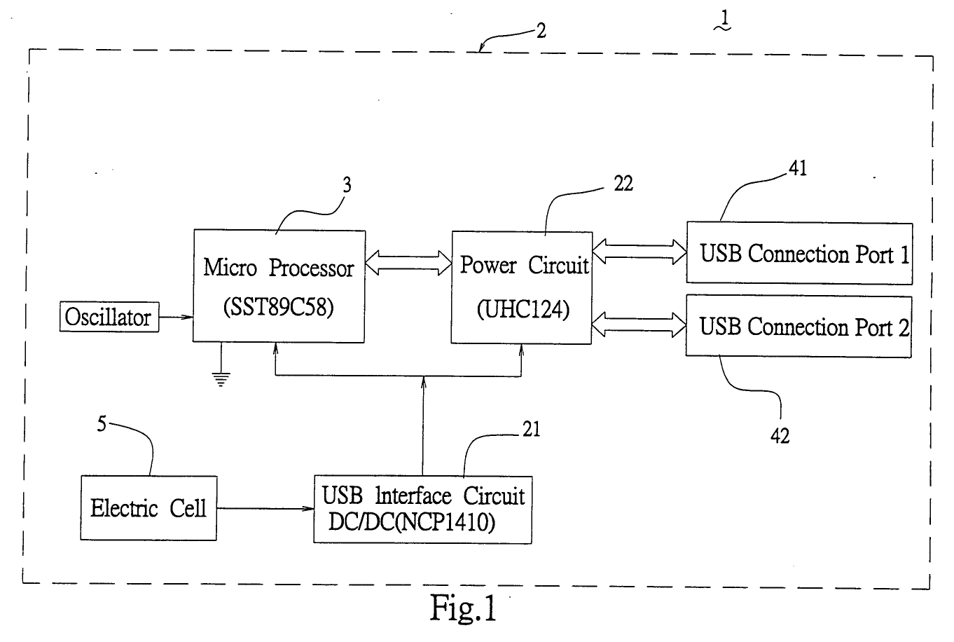

To better understand the invention, detailed descriptions shall be given with the accompanying drawings hereunder. Referring to FIG. 1, a digital data transmitter 1 comprises a circuit board 2 at least having a power circuit 21, a universal serial bus (USB) interface circuit 22, a central processing unit (CPU) 3, connectors 41 and 42, and an electric cell 5. The electric cell 5 is for providing the CPU 3 and the USB interface circuit 22 with appropriate and stable direct-current power supply. The CPU 3 has embedded registers, and is for connecting and driving operations of various components to execute commands of embedded programs for data input and output. The connectors 41 and 42 are USB connectors capable of providing high-speed data transmission by connecting with the USB interface circuit 22, and are conducted with the CPU 3 for transmitting digital data.

According to the above structure, when a user inserts and connects an information product to the two connectors 41 and 42 of the digital data transmitter 1, respectively, through operations of the CPU 3, the digital data transmitter 1 first checks whether a source device (the information product having data to be outputted, and being connected to the connector 41) has an edit file (for example, s-box001). If yes, all data in the file are copied to the registers in the CPU 3. Or, if not, all contents under a root directory are copied to the registers in the CPU 3. Next, the digital data transmitter 1 checks whether a target storage device (the information product to which the data are to be stored, and being connected to the connector 42) has other edit files (for example, s-box001, where 001 is a serial number with every new copy made increased by 1) are present. If not, a new file named s-box001 is created. Or, if yes, a new filed named s-box002, or s-box003 and so on, is created. The contents of the source storage device temporarily stored in the registers are all copied to the file in the target storage device, thereby completing an object of transmitting data between information products (memory elements) at all time.

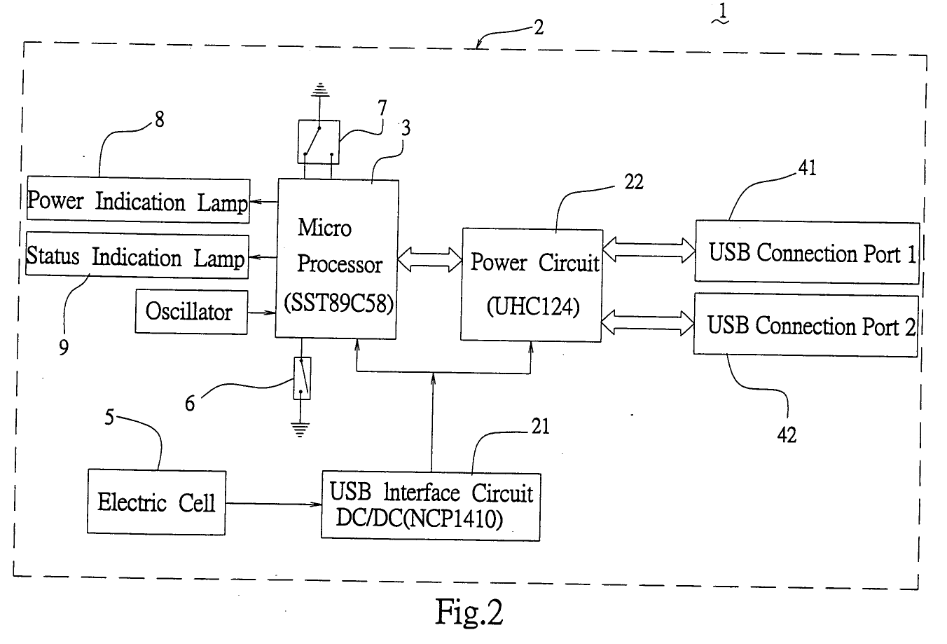

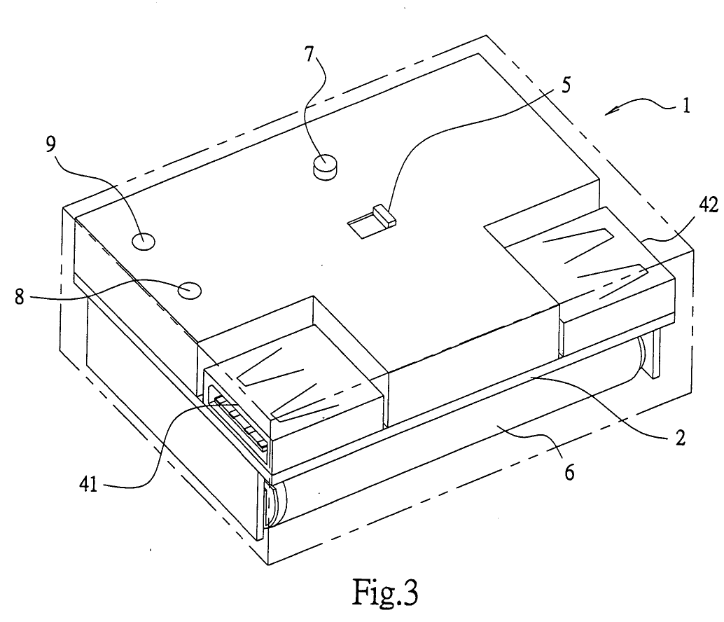

Referring to an embodiment shown in FIGS. 2 and 3, in a similar structure as shown in FIG. 1, the CPU 3 is provided with a power switch 6, a selection button 7, a power indication lamp 8, and a status indication lamp 9. The power switch 6 is for controlling timing of power supply by shutting down and thus saving the power when not in use. The selection button 7 is a selection button for files to be copied, either for selecting a specific file for copying or switching to all data files for copying with the data being stored to the target device. To facilitate operations, the power indication lamp 8 and the status indication lamp 9 are for indicating status of power supply and execution status of data transmission.

To use the aforesaid structure to transmit digital data from an information product to another information product, USB connectors of two information products having data to be transmitted are connected with the connectors 41 and 42 of the digital data transmitter 1 according to the invention. The power switch 6 is turned on, and the selection button 7 is pressed, so as to select a specific file or all files for copying and storage. Via the CPU 3 according to the aforesaid method, digital data in the source storage device (the information product containing file sources) can be directly transmitted to the target device (the information product for storing data). The user, at the same time, is able to interpret operation status of the digital data transmitter 1 from the power indication lamp 8 and the status indication lamp 9.

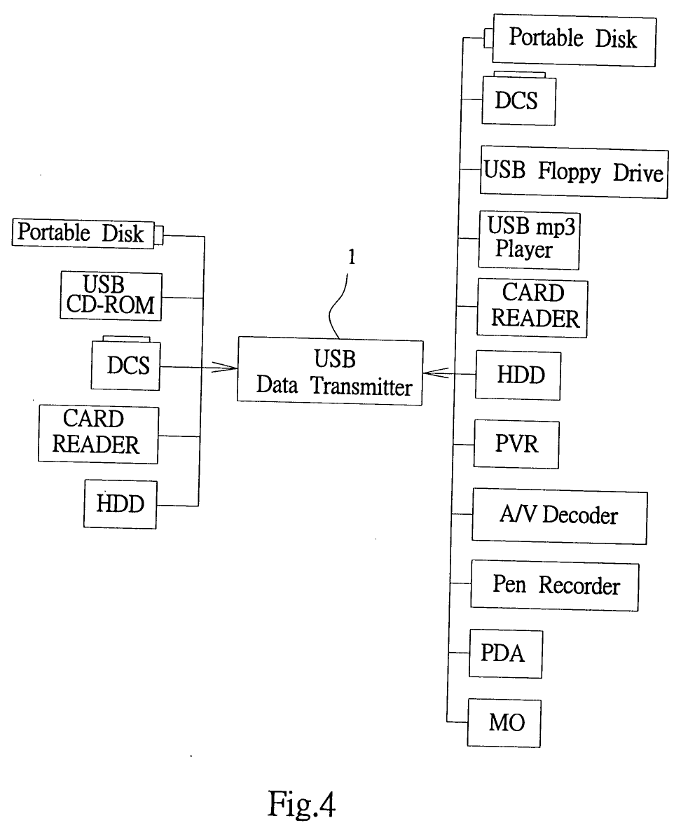

Referring to FIG. 4 showing an application of having the digital data transmitter 1 according to the invention connected with two information products, such as a portable disk and an HDD-external storage, an HDD-external storage and an HDD-external storage, an HDD-external storage and a PVR, a portable disk and an A/V decoder, a portable disk and a USB pen recorder, a portable disk and a PDA, a portable disk and a magneto-optical drive (MO), a portable disk and a portable disk, a portable disk and a DSC, a portable disk and a USB CD-ROM, a portable disk and a USB floppy drive, a portable disk and an MP3 player, and a portable disk and a card reader. Hence, conventional methods using computers as media for transmitting digital data transmission are no longer required. In stead, digital data of two information products can be transmitted to each other by connecting the two information products to the digital data transmitter 1 according to the invention.

It is of course to be understood that the embodiments described herein are merely illustrative of the principles of the invention and that a wide variety of modifications thereto may be effected by persons skilled in the art without departing from the spirit and scope of the invention as set forth in the following claims.

1. A digital data transmitter comprising a circuit board having at least a universal serial bus (USB) interface circuit, a power circuit, a central processing unit (CPU), two connectors and an electric cell; wherein:
the electric cell provides power required by operations of the CPU and the USB interface circuit;
the CPU has embedded registers, and is for connecting and driving operations of various components in order to execute commands of embedded programs for data input and output; and
the connectors are USB connectors for providing high-speed transmission, and are connected with the USB interface circuit and conducted with the CPU for further digital data transmission;
using the above structure, to transmit data stored in one information product to another information product, the two information products are connected to the connectors of the digital data transmitter using connectors thereof, and the data are directly transmitted and stored via controls of the CPU.

2. The digital data transmitter in accordance with claim 1, wherein the CPU has a power switch for controlling timing of power supply.

3. The digital data transmitter in accordance with claim 2, wherein the CPU further has a selection button for selecting a specific file or all files for copying to a target storage device.

4. The digital data transmitter in accordance with claim 3, wherein the circuit board has a power indication lamp.

5. The digital data transmitter in accordance with claim 4, wherein the circuit board has an execution status indication lamp.
